(19) United States
(12) Patent Application Publication
(10) Pub. No.: US 2026/0207029 A1
(43) Pub. Date: Jul. 23, 2026

(54) WRINGER MOP BUCKET

(71) Applicant: Xuyi GUAN, Taizhou (CN)

(72) Inventor: Xuyi GUAN, Taizhou (CN)

(21) Appl. No.: 19/033,727

(22) Filed: Jan. 22, 2025

(51) Int. Cl. A47L 13/58; B08B 1/16; B08B 1/20

(52) U.S. Cl. CPC A47L 13/58; B08B 1/165; B08B 1/20

(57) ABSTRACT

To provide a wringer mop bucket which has a small number of parts and components, its overall structure is simple, and the assembling process is convenient and rapid, facilitating the processing and fabrication. A wringer mop bucket comprises: a body; a lid, which is provided with a first receptacle, the first guide edge of the first receptacle is provided with the water inlet and the first supporting portion in a opposite manner; a scraper, which is rotatably provided at the water inlet, and the scraper protrudes from the water inlet; and when the mop head is inserted into the body from the first receptacle, the scraper squeezes and scrapes the wiping materials of the mop head, and the first supporting portion is supported on the back side of the mop head.

### TECHNICAL FIELD

The present technical solution relates to the field of wringer mop buckets for cleaning horizontal plate mops, particularly to Wringer Mop Bucket.

### BACKGROUND

The horizontal plate mop is favored by people with its simple structure and efficient and convenient cleaning capability. Meanwhile, more and more devices for cleaning the horizontal plate mop have appeared in the market. Among them, the wringer mop bucket is the most common one. The wringer mop bucket comprises a body and a lid, wherein the body is used to accommodate water for cleaning the mop. The lid is provided with components for cleaning and squeezing the horizontal plate mop to realize the cleaning and squeezing of the mop plate.

In order to efficiently squeeze the mop plate, the structure with an adjustable squeezing opening is generally provided on the lid, it is so designed that the user can conveniently lift the mop plate and apply a greater pressing force during the downward movement to efficiently scrape and squeeze the wiping materials on the mop plate. The common structure of the squeezing opening is such that a squeezing device is fixedly installed on the lid, then an oblique slideway or mounting groove is provided on a side opposite to the squeezing device, a roller is installed in the slideway or mounting groove, and the roller moves up and down with the mop head and slides in the oblique slideway or mounting groove to realize the water removal of the mop head by squeezing. There is also a structure in which a squeezing module is installed on the lid or a scraper is directly installed on the lid, and then a spring is used to control the movement of the scraper. In order to facilitate the installation of the scraper or squeezing assembly, the lid generally needs to be divided into an upper layer and a lower layer, and the clamping lid in the upper layer will be closed after the structure related to the squeezing assembly is installed on the lower layer.

In the above structures, it is necessary to plan mounting positions for parts and components on the lid and to assemble multiple parts and components to the lid. The assembly process is complicated, making the overall structure of the wringer mop bucket more complicated, and in addition, multiple fabrication molds are required to make the parts and components, which increases the production cost.

### SUMMARY

The present technical solution is to provide Wringer Mop Bucket, which has a small number of parts and components, a simple overall structure, a convenient and fast assembly process, and is easy to process and manufacture.

The purpose of the present technical solution is so achieved that:

Wringer Mop Bucket, which comprises:

### a body

a lid, which is mounted on the body and is provided with a first receptacle for inserting the mop head into the body, the edge of the first receptacle extends toward one end of the said body to form a first guide edge, and a water inlet and a first supporting portion are provided on the first guide edge in a opposite manner;

a scraper, which is rotatably provided at the said water inlet, and the said scraper protrudes from the said water inlet; and

when the mop head is inserted into the said body from the said first receptacle, the said scraper squeezes and scrapes the wiping materials on the front side of the said mop head, and the first supporting portion is supported on the back side of the mop head.

Preferably, a plurality of first guide ribs are evenly arranged on the upper surface of the said scraper, and the ends of the said first guide ribs extend to the edge of the scraper, with the end close to the said first receptacle is of an arc shape.

Preferably, the said first supporting portion is a first supporting protrusion which is integrally formed on the first guide edge; and the said first supporting protrusion is a rectangular bar provided along the height direction of the first guide edge, and the upper side of the said rectangular bar is of an arc shape.

Preferably, the said first supporting portion is a roller I provided on the first guide edge, and the said roller I is provided with a rotating shaft I. The first guide edge is provided with a mounting hole I matching the rotating shaft I, the said roller I is rotatably provided in the mounting hole I, and the roller I protrudes from the first guide edge.

Preferably, a assembling plate is provided on the side of the said water inlet away from the said first receptacle, one side of the said scraper is connected to the assembling plate in a hinged manner, and the other side is rotatably provided at the said water inlet; and

When the scraper is overlapped on the lower edge of the water inlet, the upper surface of the scraper is inclined toward one side of the assembling plate.

Preferably, the assembling plate is integrally formed with the lid, pivots are provided at both ends of the scraper, and rotation holes matching the pivots are provided on the lower side of the said assembling plate;

The height for the lower edge of the said water inlet is higher than that of the rotation hole; and

Two assembling plates are provided, and reinforcing ribs are provided at the back thereof.

Preferably, the lid is also provided with a second receptacle, the edge of the second receptacle extends into the body to form a second guide edge, the second guide edge is provided with a supporting frame, and the supporting frame is provided with a plurality of layers of cleaning teeth for cleaning the mop head;

A first water seepage hole is provided between the adjacent cleaning teeth; and a second water seepage hole and a connecting strip are provided above the said supporting frame, and the second water seepage hole and the connecting strip are arranged on the second guide edge in a spacing manner.

Preferably, the supporting frame is connected to the second guide edge through the connecting strip, and the connecting strip is provided with a second guide rib. The upper portion of the second guide rib is arc-shaped, the lower portion of the second guide rib is connected to the cleaning teeth, and the cleaning teeth, the supporting frame and the second guide edge are integrally formed.

Preferably, a second supporting portion is provided on the second guide edge, and the second supporting portion and the supporting frame are arranged in an opposite manner;

When the mop head is inserted into the body from the second receptacle, the cleaning teeth scrape and clean the wiping materials of the mop head, and the second supporting portion is supported on the back side of the mop head; and

The second supporting portion is a second supporting protrusion which is integrally formed on the second guide edge; and the second supporting protrusion is a rectangular bar provided along the height direction of the second guide edge, and the upper side of the rectangular bar is of an arc shape.

Preferably, the side of the first guide edge away from the water inlet and the side of the second guide edge away from the supporting frame are respectively recessed to form an avoidance groove, and the avoidance groove is used for passing the connecting position of the mop head and the mop rod; and the first supporting portion is provided on both sides of the avoidance groove for the first guide edge, and the second supporting portion is provided on both sides of the avoidance groove for the second guide edge.

Preferably, the second supporting portion is a roller II provided on the second guide edge, and the said roller II is provided with a rotating shaft II. The second guide edge is provided with a mounting hole II matching the rotating shaft II, the roller II is rotatably provided in the mounting hole II, and the roller II protrudes from the second guide edge.

Preferably, a clamping plate is integrally formed at the lower portion of both sides for the lid, clamping teeth are integrally formed on the clamping plate; and the lid is provided with identifications for distinguishing washing and scraping.

Preferably, the body is provided with a partition, which is to divide the body into a first accommodating area and a second accommodating area, wherein the first accommodating area and the second accommodating area respectively correspond to the first receptacle and the second receptacle; the bottom on the side of the first accommodating area and the second accommodating area are provided with drain outlets; and the body is also provided with a handle.

Compared with the prior art, the present technical solution has the following outstanding and beneficial technical effects that:

1.In the present technical solution, a first guide edge is designed on the edge of the first receptacle, making the first guide edge extend toward one side of the body to guide the up and down movement of the mop head in the first receptacle, ensuring that the mop head is not skewed or collided with the bucket wall during scraping and cleaning, thereby ensuring the normal use of the wringer mop bucket. In addition, the first guide edge also serves as a connection point for the first supporting portion, which reduces the additional structure and space required on the lid for installing functional components, simplifies the lid design, facilitates manufacturing, and reduces the cost.

2.The first guide edge designed in the present technical solution is provided with a water inlet, which is realized by a through hole. A rotatable scraper is installed at the water inlet to squeeze and scrape the wiping materials on the mop head. The upper surface of the scraper is designed to be inclined backwards to guide the sewage back into the body. An assembling plate which is directly formed with the lid is provided behind the water inlet, and a rotation hole is opened on the assembling plate. Pivots are provided at both ends of the scraper, and the scraper can be fixed to the lid by inserting them into the rotation hole. As the mop head moves up and down, the scraper can adjust the squeezing force on the mop head, and no additional structures or components are required, so that overall components are less, and it is easy to install.

3.The rectangular bar designed in the present technical solution is supported on the back side of the mop head, so that the supporting force of the mop head is enhanced, the mop head can always slide into the first receptacle in the vertical direction to be in maximum contact with the cleaning teeth or the scraper, thereby maintaining the cleaning or squeezing effect.

4.The supporting member, cleaning teeth and lid are integrally formed, so that only the scraper needs to be installed after the lid is processed, which has the effect of cleaning and scraping with good scraping force, thereby reducing the number of parts and components of the wringer mop bucket, simplifying the structure, ensuring the use effect, and reducing the processing and fabrication cost of the wringer mop bucket.

5.In the design of the present technical solution, a partition is provided in the body to divide the space in the body into a first accommodating area and a second accommodating area. In this way, during the assembly process, there is no need to distinguish the corresponding relationship between the two receptacles and the two accommodating areas, thereby improving the compatibility and practicality of the body and improving the work efficiency of the wringer mop bucket during assembling.

6.The lid designed in the present technical solution is provided with an integrally formed clamping plate, which is directly clamped to the edge of the body opening through elastic deformation of the clamping plate, so that the body and the lid are clamped and fixed together, eliminating the need for fixed installation of the clamping plate.

### BRIEF DESCRIPTION OF DRAWINGS

FIG. 1 is a schematic diagram for the structure of the present technical solution.

FIG. 2 is an exploded view of the present technical solution.

FIG. 3 is a sectional view for the local part of the present technical solution.

FIG. 4 is a schematic diagram for the structure without installing the scraper onto the lid in the present technical solution.

FIG. 5 is a schematic diagram for the structure of the scraper in the present technical solution.

FIG. 6 is the schematic diagram I for the structure with the scraper installed onto the lid in the present technical solution.

FIG. 7 is the schematic diagram II for the structure with the scraper installed onto the lid in the present technical solution.

Reference numerals: 1. Body; 11. Partition; 12. First accommodating area; 13. Second accommodating area; 14. Drain outlet;

2.Lid; 21. First receptacle; 22. First guide edge; 23. Water inlet; 24. Lower edge; 25. Assembling plate; 26. Reinforcing rib; 27. rotation hole; 28. Clamping plate; 29. First supporting portion; 211. Rectangular bar; 212. Second receptacle; 213. Second guide edge; 214. Supporting frame; 215. Cleaning teeth; 216. Second water seepage hole; 217. First water seepage hole; 218. Connecting strip; 219. Second supporting portion; 221. Second guide rib; 222. Avoidance groove; 223. Identification;

3.Scraper; 31. First guide rib; 32. Pivot;

4.Sealing plug; 5. Handle.

### DESCRIPTION OF EMBODIMENTS

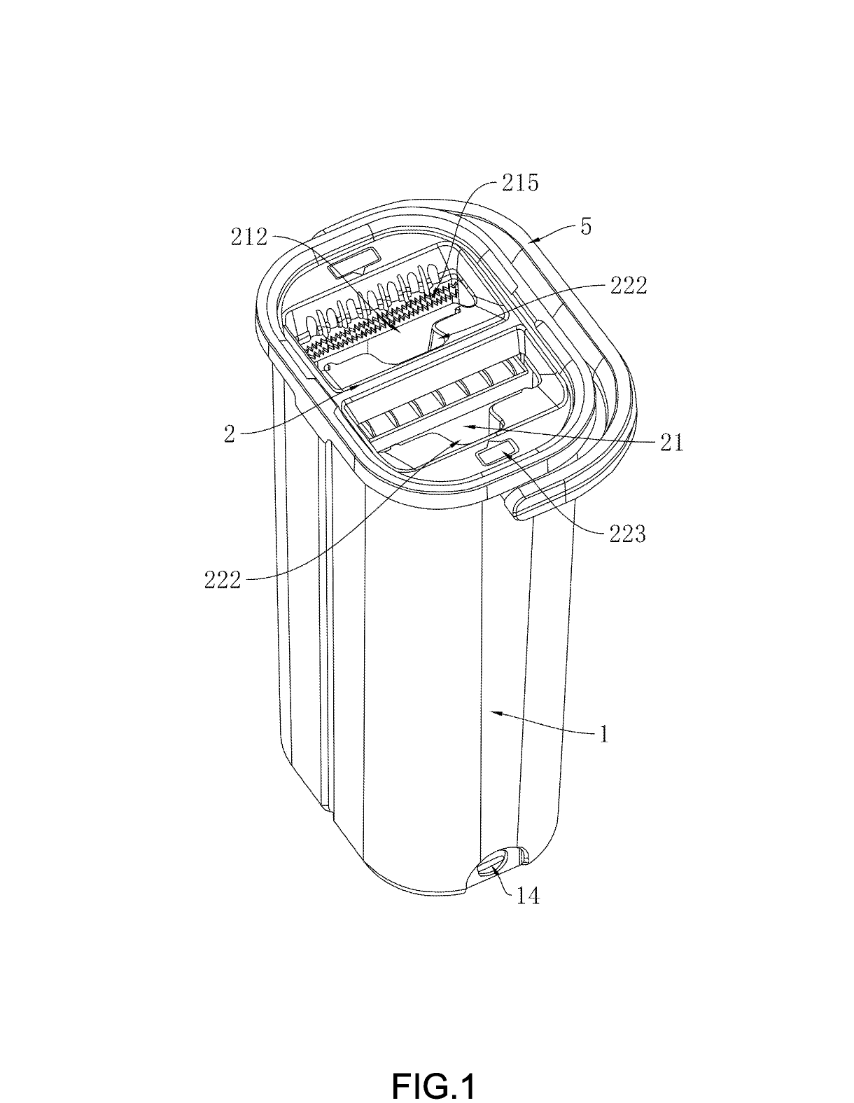

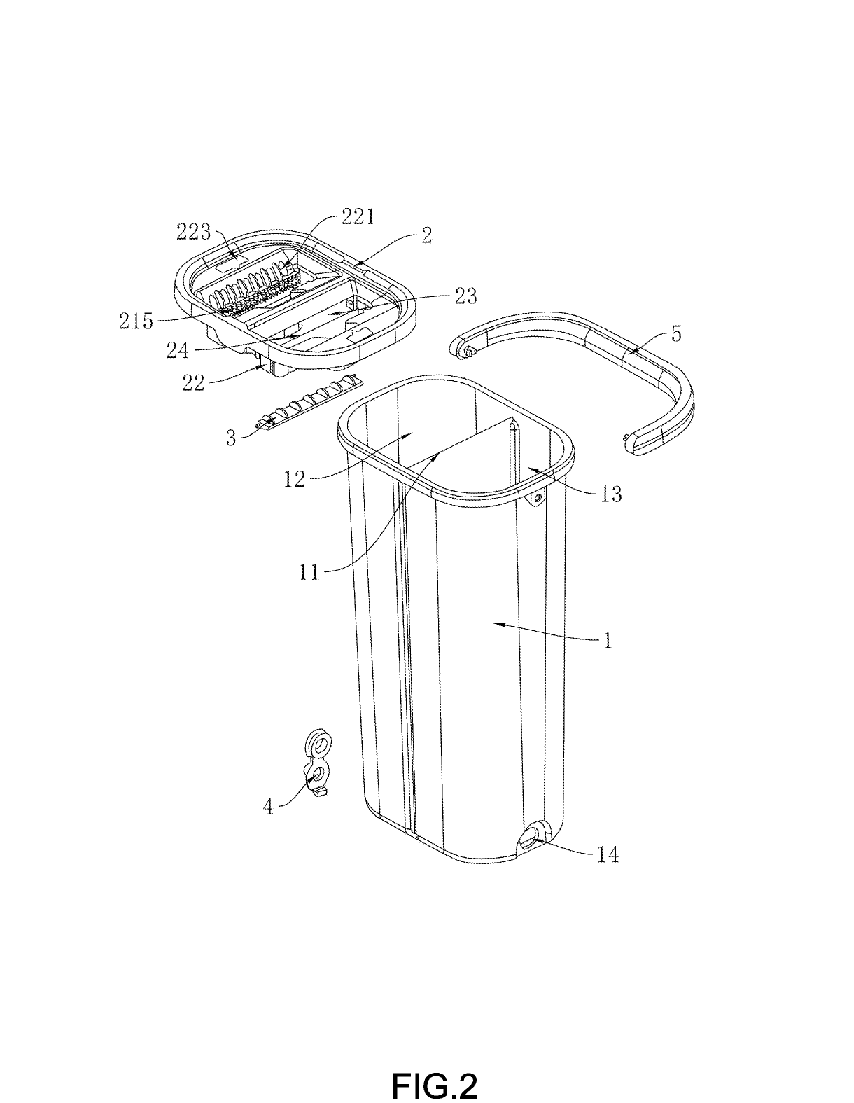

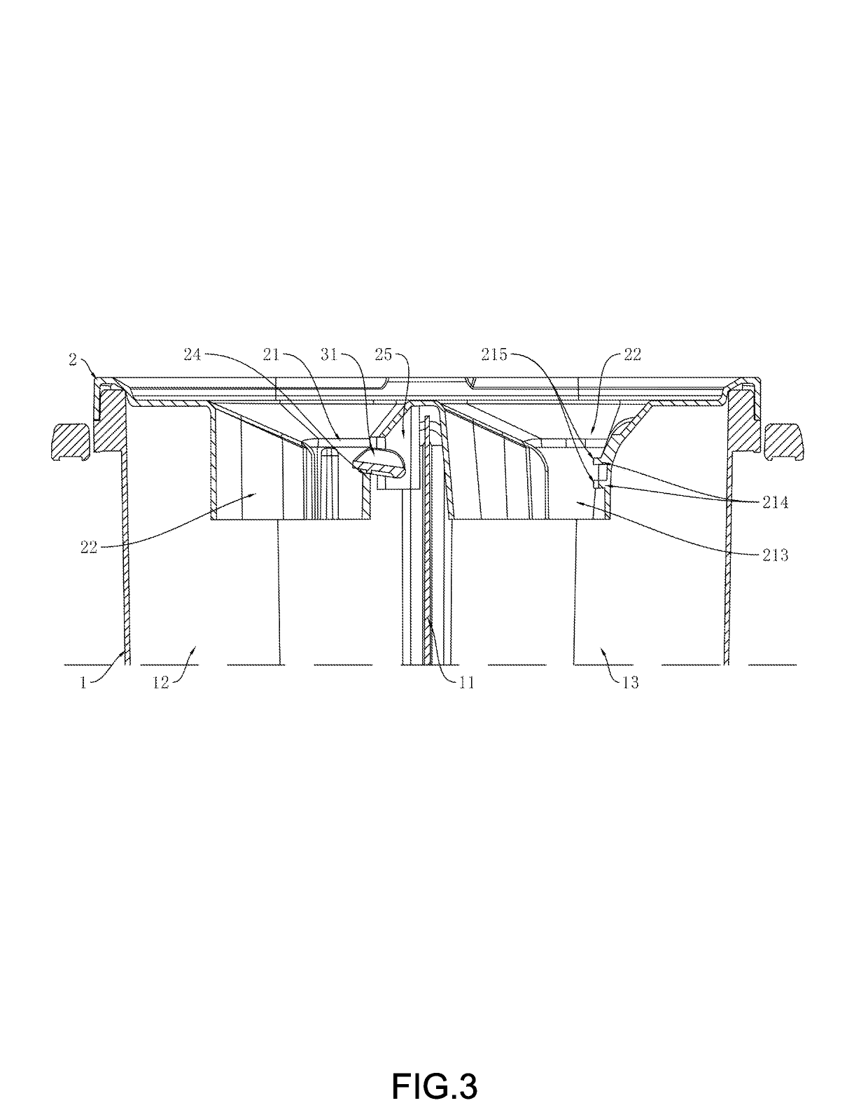

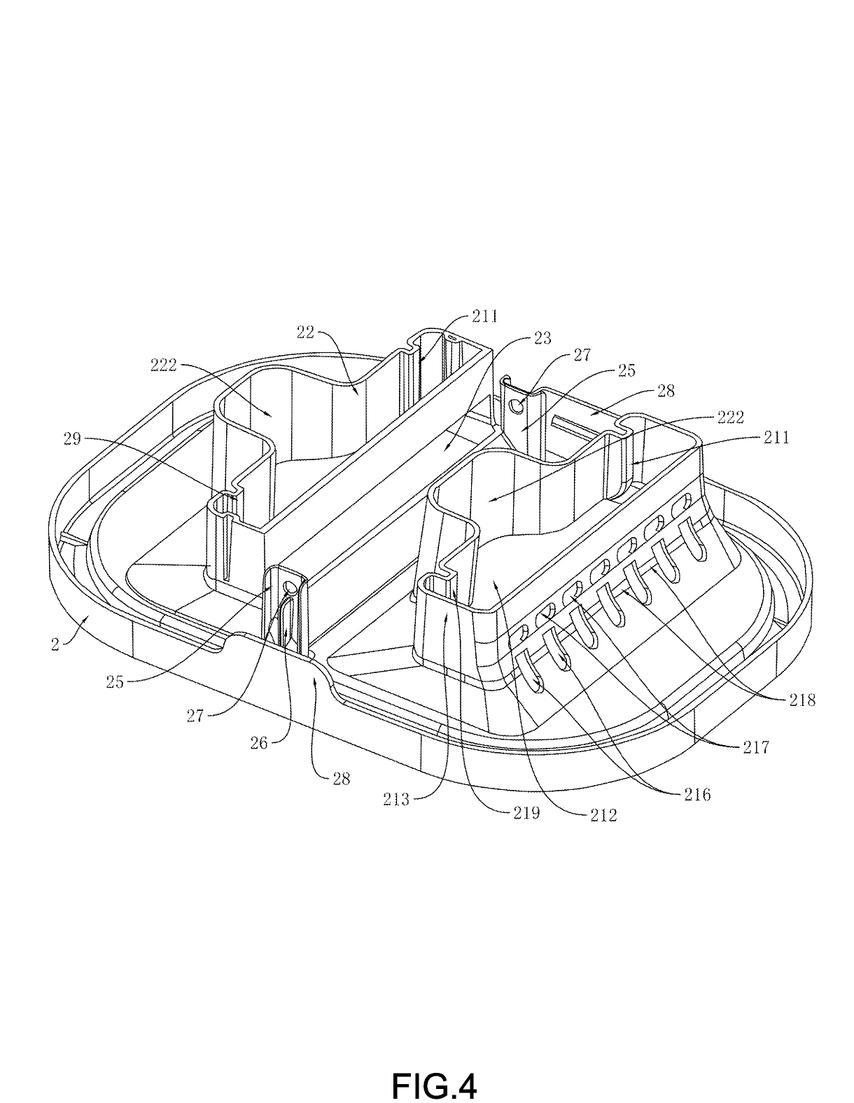

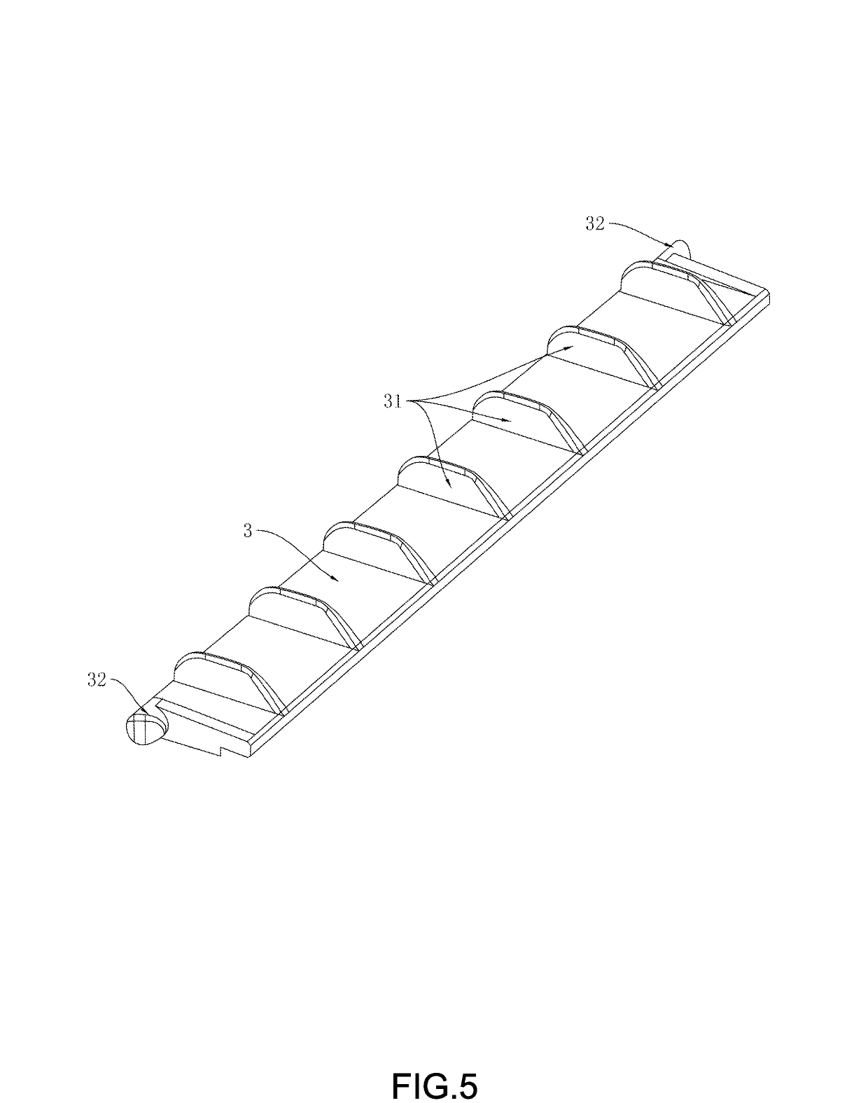

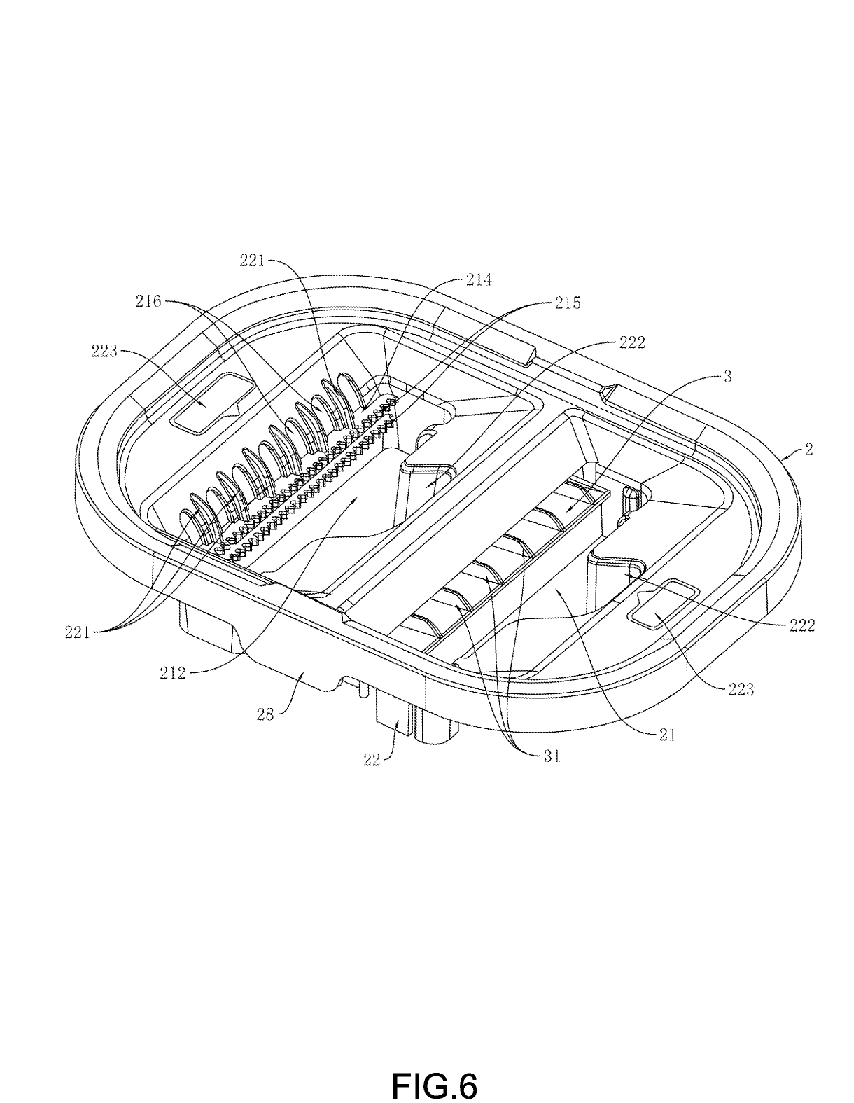

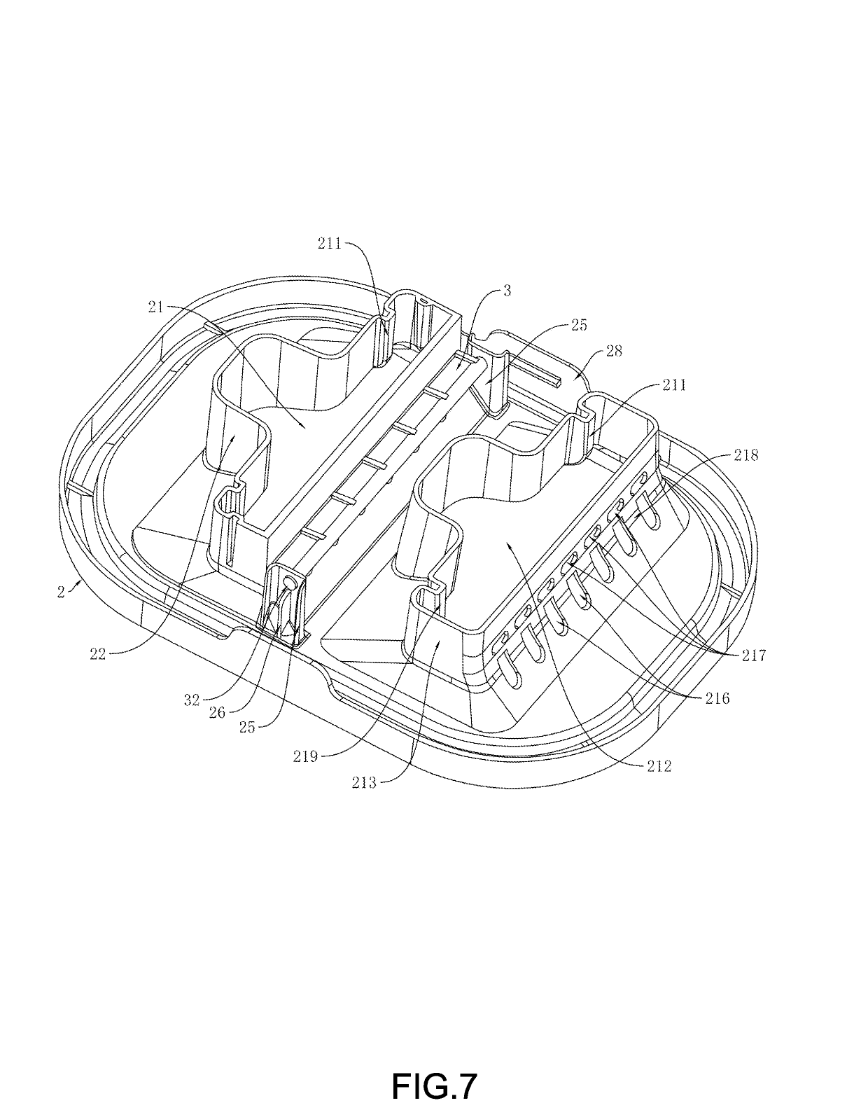

The present technical solution will be further described below with reference to specific embodiment in conjunction with the drawings. See FIGS. 1 to 7.

Wringer Mop Bucket comprises a body 1, the body 1 is provided with a lid 2, the lid 2 is provided with a first receptacle 21, a mop head can be inserted into the body 1 through the first receptacle 21, the edge of the first receptacle 21 extends to one side of the body 1 to form a first guide edge 22, a water inlet 23 is provided on the first guide edge 22, an assembling plate 25 is provided on one side of the water inlet 23 away from the first receptacle 21, one side of the scraper 3 is connected onto the assembling plate 25 in a hinged manner, the other side rotates at the water inlet 23, and the scraper 3 protrudes from the water inlet 23; and the first supporting portion 29 is provided on the first guide edge 22 of the side opposite to the water inlet 23, when the mop head is inserted into the body 1 from the first receptacle 21, the scraper 3 squeezes and scrapes the wiping materials of the mop head, and the first supporting portion 29 is supported on the back side of the mop head.

When the scraper 3 overlaps the lower edge 24 of the water inlet 23, the upper surface of the scraper 3 is inclined toward the side of the assembling plate 25, so that the water away from the mop head scraped by the scraper 3 can flow into the body 1 along the scraper 3, avoiding the scraped water being absorbed by the wiping materials of the mop head again to affect the scraping effect, thereby ensuring the scraping effect of the mop head.

The thickness of the scraper 3 gradually becomes thinner toward the side of the assembling plate 25, or a supporting edge is provided at the bottom of the scraper 3 to be supported on the lower edge 24, so as to ensure the drainage effect of the scraper 3. In this embodiment, the two ends of the scraper 3 are provided with pivots 32, two assembling plates 25 are provided, rotation holes 27 matching the pivots 32 are provided on the lower side, making the pivots 32 inserted into the rotation holes 27 to install the scraper 3 on the assembling plate 25, and the height of the rotation hole 27 is lower than that of the lower edge 24 for the water inlet 23, therefore the scraper 3 can form an angle inclined toward the side of the assembling plate, the structure is simple, and it is easy to fabricate.

Further, the assembling plate 25 is integrally formed with the lid 2, and a reinforcing rib 26 is provided on the back of the assembling plate 25 to strengthen the connection with the lid 2 and enhance the supporting strength of the assembling plate 25.

The upper surface of the scraper 3 is evenly provided with a plurality of first guide ribs 31, and the end of the first guide rib 31 extends to the edge of the scraper 3, with the end close to the first receptacle 21 of an arc shape; the first supporting portion 29 is a first supporting protrusion provided on the first guide edge 22, and the first supporting protrusion is a rectangular bar 211 provided along the height direction of the first guide edge 22, so that the supporting force on the mop head can be increased, making the mop head always have good contact with the scraper in a vertical state, and the effect of water scraping can be ensured.

The upper side of the rectangular bar 211 is arc-shaped, so that when the mop head is inserted into the first receptacle 21, the arc-shaped first guide rib 31 and the arc-shaped rectangular bar 211 guide the mop head to move quickly and smoothly into the body 1, avoiding the mop head from being stuck at the first receptacle 21, and also guiding the up and down movement of the mop head.

Further, the first supporting protrusion, the first guide edge 22 and the lid 2 are integrally formed, which is convenient for the processing and fabrication of the lid 2, and the processing cost is reduced.

In a preferred case, the lid 2 is further provided with a second receptacle 212, the edge of the second receptacle 212 extends into the body 1 to form a second guide edge 213, the second guide edge 213 is provided with a supporting frame 214, the supporting frame 214 is provided with a plurality of layers of cleaning teeth 215, and the cleaning teeth 215 protrude from the supporting frame 214 for cleaning the mop head; and a second supporting portion 219 is provided on the second guide edge 213 on the side opposite to the supporting frame 214, when the mop head is inserted into the body 1 from the second receptacle 212, the cleaning teeth 215 scrapes and cleans the wiping materials of the mop head, and the second supporting portion 219 is supported on the back side of the mop head.

Further, a first water seepage hole 127 is provided between two adjacent layers of cleaning teeth 215, a second water seepage hole 216 and a connecting strip 218 are provided above the supporting frame 214, the supporting frame 214 is connected to the second guide edge 213 through the connecting strip 218, the second water seepage hole 216 and the connecting strip 218 are provided on the second guide edge 213 in a spacing manner, and the second water seepage hole 216 and the first water seepage hole 217 facilitate the discharge of sewage and garbage cleaned from the wiping materials from the cleaning teeth 215 into the body to avoid adhering to the wiping materials of the mop head.

Further, a second guide rib 221 is provided on the connecting strip 218, the upper part of the second guide rib 221 is arc-shaped, with the lower part being connected to the cleaning teeth 215; the second supporting portion 219 is a second supporting protrusion provided on the second guide edge 213, the second supporting protrusion is a rectangular bar 211 provided along the height direction of the second guide edge 213, and the upper side of the rectangular bar 211 is arc-shaped. When the mop head is inserted into the second receptacle 212, the arc-shaped second guide rib 221 and the arc-shaped rectangular bar 211 guide the mop head to move quickly and smoothly into the body 1, avoiding the mop head from getting stuck at the second receptacle 212, and also guiding the up and down movement of the mop head.

Further, the cleaning teeth 215, the supporting frame 214, the second guide edge 213, the second supporting protrusion and the lid 2 are integrally formed, which is convenient for the processing and fabrication of the lid 2.

The first supporting portion 29 is a roller I provided on the first guide edge 22, the roller I is provided with a rotating shaft I, the first guide edge 22 is provided with a mounting hole I matching the rotating shaft I, the roller I protrudes from the first guide edge 22 and can rotate in the mounting hole I, and the roller I rotates with the up and down movement of the mop head, so that the mop head moves smoothly at the first receptacle; and the second supporting portion 219 is a roller II provided on the second guide edge 213, the roller II is provided with a rotating shaft II, the second guide edge 213 is provided with a mounting hole II matching the rotating shaft II, the roller II protrudes from the second guide edge 213 and can rotate in the mounting hole II, and the roller II rotates with the up and down movement of the mop head, so that the mop head moves more smoothly at the second receptacle.

The side of the first guide edge 22 away from the water inlet 23 and the side of the second guide edge 213 away from the supporting frame 214 are respectively recessed to form an avoidance groove 222, and when the mop head moves up and down at the first receptacle 21 or the second receptacle 212, the connecting position of the mop head and the mop rod can conveniently passes through the avoidance groove 222.

Further, the first supporting portion 29 and the second supporting portion 219 are provided on both sides of the avoidance groove 222, so that the supporting force of the rectangular bar 211 on the mop head can be more uniform and stable.

The lower part on both sides of the lid 2 is provided with a clamping plate 28, the clamping plate 28 is provided with clamping teeth, the opening edge of the body 1 is provided with a clamping edge matching the clamping teeth, making the lid 2 cover in the opening position of the body 1 after the clamping plate 28 is turned outward, and the lid 2 can be fixed on the body 1 in a clamping manner by just releasing the clamping plate 28. The clamping teeth, the clamping plate 28 and the lid 2 are integrally formed, further reducing the number of parts and components of the wringer mop bucket and reducing the processing cost; and the lid 2 is also provided with an identification 223 for distinguishing washing and scraping, facilitating the users to use the washing and scraping receptacles more quickly.

Further, a partition 11 is provided in the body 1 to divide the inner chamber of the body 1 into a first accommodating area 12 and a second accommodating area 13, and the first accommodating area 12 and the second accommodating area 13 correspond to the first receptacle 21 and the second receptacle 212 respectively. In this way, the relative position of the lid 2 and the body 1 does not need to be distinguished during assembly, which simplifies the assembly process of the wringer mop bucket and improves the assembling efficiency and convenience.

Furthermore, drain outlets 14 are provided at the bottom of the side for at least one of the first accommodating area 12 and the second accommodating area 13, and when only one of the first accommodating area 12 and the second accommodating area 13 is provided with drain outlets 14 at the bottom of the side, gaps making the first accommodating area 12 and the second accommodating area 13 communicated are provided on the lower end of the partition 11 and the bottom of the inner chamber for the body 1; when the bottoms of the sides for the first accommodating area 12 and the second accommodating area 13 are provided with drain outlets 14, the partition 11 can choose to completely separate the first accommodating area 12 and the second accommodating area 13, so that liquid cannot flow back and forth between the first accommodating area 12 and the second accommodating area 13; and the drain outlet is provided with a sealing plug 4 to block the drain outlet, and the sealing plug can be easily pulled out to drain the sewage in the body 1, so that it is convenient to use. A handle 5 is also provided on the body 1 to facilitate the taking and moving of the wringer mop bucket.

In the above technical solution, the pivots 32 of the scraper 3 are inserted into the rotation hole 27 of the assembling plate 25, the lid 2 is fixed on the body 1 in a clamping manner, and the assembling of the wringer mop bucket is completed. In this way, the number of overall parts and components is small, which is convenient for assembling and reduces the processing cost of the wringer mop bucket.

When in use, the mop head moves up and down at the second receptacle 212, the rectangular bar 211 resists against the back side of the mop head, and the cleaning teeth clean the wiping materials of the mop head. After the cleaning is completed, the mop head is squeezed and scraped dry. The mop head moves up and down at the second receptacle 212 to squeeze and scrape the wiping materials on the mop head; as the mop head moves upward, the scraper 3 rotates upward at the water inlet 23 with the pivots 32 as the axis, which shortens the length of the scraper 3 protruding from the water inlet 23, that is, the squeezing force of the scraper 3 on the wiping materials of the mop head is reduced, so that the mop head can be easily pulled out upwards; and when the mop head is inserted downwards, the scraper 3 rotates downwards at the water inlet 23 with the pivots 32 as the axis to increase the length of the scraper 3 protruding from the water inlet 23, until the scraper 3 overlaps the lower edge of the water inlet 23 and the squeezing force of the scraper 3 on the wiping materials of the mop head is the largest. At this time, the scraper 3 scrapes the water from the wiping materials of the mop head, and then the scraped water flows along the inclined upper surface of the scraper 3 to the side of the assembling plate, flows down from the scraper 3, and falls into the inside of the body, indirectly ensuring the scraping and squeezing effect.

The above shows and describes the basic principles, main features and advantages of the present technical solution. It should be understood by those skilled in the industry that the present technical solution is not limited to the above embodiment. The description in the above embodiment and specification are only used for explaining the principles of the present technical solution. Without departing from the spirit and scope of the present technical solution, the present technical solution may have various variations and improvements, which fall within the protection scope of the present technical solution.

What is claimed is:

1. A Wringer Mop Bucket, it is characterized in that it comprises:
a body;
a lid, which is mounted on the said body, the said lid is provided with a first receptacle, the said first receptacle is used for inserting the mop head into the body, the edge of the said first receptacle extends toward one end of the said body to form a first guide edge, and a water inlet and a first supporting portion are provided on the said first guide edge in a opposite manner;
a scraper, which is rotatably provided at the said water inlet, and the said scraper protrudes from the said water inlet; and
when the mop head is inserted into the said body from the said first receptacle, the said scraper squeezes and scrapes the wiping materials on the front side of the said mop head, and the first supporting portion is supported on the back side of the mop head.

2. The Wringer Mop Bucket according to claim 1, it is characterized in that:
a plurality of first guide ribs are evenly arranged on the upper surface of the said scraper, and the ends of the said first guide ribs extend to the edge of the scraper, with the end close to the said first receptacle is of an arc shape.

3. The Wringer Mop Bucket according to claim 2, it is characterized in that:
the said first supporting portion is a first supporting protrusion which is integrally formed on the first guide edge; and the said first supporting protrusion is a rectangular bar provided along the height direction of the first guide edge, and the upper side of the said rectangular bar is of an arc shape.

4. The Wringer Mop Bucket according to claim 2, it is characterized in that:
the said first supporting portion is a roller I provided on the first guide edge, the said roller I is provided with a rotating shaft I, the first guide edge is provided with a mounting hole I matching the rotating shaft I, the said roller I is rotatably provided in the mounting hole I, and the roller I protrudes from the first guide edge.

5. The Wringer Mop Bucket according to claim 1, it is characterized in that:
an assembling plate is provided on the end of the said water inlet away from the said first receptacle, one side of the said scraper is connected to the assembling plate in a hinged manner, and the other side is rotatably provided at the said water inlet; and
when the said scraper is overlapped on the lower edge of the said water inlet, the upper surface of the said scraper is inclined toward one side of the assembling plate.

6. The Wringer Mop Bucket according to claim 5, it is characterized in that:
the said assembling plate is integrally formed with the lid, pivots are provided at both ends of the said scraper, and rotation holes matching the pivots are provided on the lower side of the said assembling plate;
the height for the lower edge of the said water inlet is higher than that of the said rotation hole; and
two assembling plates are provided, and reinforcing ribs are provided at the back thereof.

7. The Wringer Mop Bucket according to claim 1, it is characterized in that:
the said lid is also provided with a second receptacle, the edge of the said second receptacle extends into the body to form a second guide edge, the said second guide edge is provided with a supporting frame, and the said supporting frame is provided with a plurality of layers of cleaning teeth for cleaning the mop head;
a first water seepage hole is provided between the adjacent cleaning teeth; and a second water seepage hole and a connecting strip are provided above the said supporting frame, and the second water seepage hole and the connecting strip are arranged on the second guide edge in a spacing manner.

8. The Wringer Mop Bucket according to claim 7, it is characterized in that:
the said supporting frame is connected to the second guide edge through the said connecting strip, the said connecting strip is provided with a second guide rib, the upper portion of the said second guide rib is arc-shaped, the lower portion is connected to the cleaning teeth, and the said cleaning teeth, the supporting frame and the said second guide edge are integrally formed.

9. The Wringer Mop Bucket according to claim 7, it is characterized in that:
a second supporting portion is provided on the second guide edge, and the second supporting portion and the supporting frame are arranged in an opposite manner;
when the mop head is inserted into the body from the second receptacle, the cleaning teeth scrape and clean the wiping materials of the mop head, and the said second supporting portion is supported on the back side of the mop head; and
the said second supporting portion is a second supporting protrusion which is integrally formed on the second guide edge; and the said second supporting protrusion is a rectangular bar provided along the height direction of the second guide edge, and the upper side of the said rectangular bar is of an arc shape.

10. The Wringer Mop Bucket according to claim 9, it is characterized in that:
the side of the said first guide edge away from the water inlet and the side of the said second guide edge away from the supporting frame are respectively recessed to form an avoidance groove, and the said avoidance groove is used for passing the connecting position of the mop head and the mop rod; and the said first supporting portion is provided on both sides of the avoidance groove for the first guide edge, and the second supporting portion is provided on both sides of the avoidance groove for the second guide edge.

11. The Wringer Mop Bucket according to claim 9, it is characterized in that:
the said second supporting portion is a roller II provided on the second guide edge, the said roller II is provided with a rotating shaft II, the second guide edge is provided with a mounting hole II matching the rotating shaft II, the roller II is rotatably provided in the mounting hole II, and the roller II protrudes from the second guide edge.

12. The Wringer Mop Bucket according to claim 11, it is characterized in that:
a clamping plate is integrally formed at the lower portion of both sides for the said lid, clamping teeth are integrally formed on the said clamping plate; and the lid is provided with identifications for distinguishing washing and scraping.

13. The Wringer Mop Bucket according to claim 11, it is characterized in that:
the said body is provided with a partition to divide the body into a first accommodating area and a second accommodating area, wherein the said first accommodating area and the second accommodating area respectively correspond to the said receptacle and the second receptacle; the bottom on the side of the said first accommodating area and/or the second accommodating area are provided with drain outlets; and the said body is provided with a handle.
